(19) United States
(12) Patent Application Publication
(10) Pub. No.: US 2013/0325613 A1
(43) Pub. Date: Dec. 5, 2013

(54) System and method for displaying geo-location based video advertisements with advertisements layered on top of video advertisements that incorporate an Add to Cart button or other button of the likes

(71) Applicant: Thien Van Pham, Lacey, WA (US)

(72) Inventor: Thien Van Pham, Lacey, WA (US)

(73) Assignee: Thien Van Pham, Lacey, WA (US)

(21) Appl. No.: 13/482,946

(22) Filed: May 29, 2012

(51) Int. Cl. G06Q 30/02; G06Q 30/06

(52) U.S. Cl. 705/14.58; 705/14.49

(57) ABSTRACT

A system and method for displaying geo-location based advertisement videos that contains advertisements with “Add to Cart” button or other button of the likes within an online video, allowing the viewer to add products and/or services to a shopping cart, displaying the shopping cart when the online video is done playing or when the viewer clicks on a checkout button, and allowing the viewer to pay for the products and services using his/her credit card or other payment methods.

### CROSS-REFERENCE TO RELATED APPLICATIONS

Not Applicable.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates generally to advertisement videos using geo-location to determine the type of video advertisements to present to viewers and allowing viewers to add products and/or services to a shopping cart for checkout when the online video is done playing or when the viewer clicks on the checkout button or any other button of the likes that takes the viewer to the shopping cart for payment processing. Online advertisement videos today are just for viewing and clicking on advertisements will either open a new window or redirect the viewer to another page for further information. Once the click occurs, the viewer is then redirected to another website associated to the advertisement video.

The process of interacting with viewers and allowing them to add products and/or services with just a click of the “Add to Cart” button or other button of the likes while watching advertisement videos and allowing viewers to purchase products and/or services when the online video is done playing or when viewers click on the checkout button or any other button of the likes that takes the viewer to the shopping cart for payment processing has not been done before.

What is needed is a system and method for showing geo-location based advertisement videos within online videos (such as movies, episodes, reality TV shows, etc.), clicking the “Add to Cart” button or other button of the likes that appears within advertisement videos, adding products and/or services to a shopping cart, and displaying the shopping cart for checkout when the online video is done playing or when the viewer clicks on the checkout button or other button of the likes that takes the viewer to the shopping cart for payment processing.

### BRIEF SUMMARY OF THE INVENTION

The invention comprise of a video player software that shows online videos (such as movies, episodes, reality TV shows, etc.) that dynamically shows advertisement videos based on geo-location of viewers and allowing viewers to click on the “Add to Cart” button or other button of the likes, stores the products and/or services to a shopping cart, and displays the shopping cart for checkout when the online video is done playing or when viewers click on the checkout button or other button of the likes that takes the viewer to the shopping cart for payment processing.

In a typical application, the viewer watches an online video. While the online video is playing, at various times in the online video, the video player pauses the online video and plays the advertisement videos based on the geo-location of the viewer. While the advertisement video is playing, an advertisement with an “Add to Cart” button appears over the advertisement video that allows the viewer to click on. Once the viewer clicks the “Add to Cart” button or other button of the likes, the product or service is then added to the shopping cart. When the advertisement videos are done playing, the video player resumes the online video where it last paused. Once the online video is done playing or when the viewer clicks on the checkout button or other button of the likes, the video player then displays the shopping cart for checkout. At checkout, the viewer changes the quantity of the products and/or services, updates the shopping cart, and then pays for the products and services in the shopping cart using his/her credit card or other payment methods.

### BRIEF DESCRIPTION OF THE SEVERAL VIEWS OF THE DRAWING

FIG. 1 illustrates two geo-location based advertisement videos with advertisements that contain an “Add to Cart” button within an online video.

### DETAILED DESCRIPTIONS OF THE INVENTION

The invention is now described in detail with reference to an embodiment thereof as illustrated in the accompanying drawing. In the following description, numerous specific details are set forth in order to provide thorough understanding of the present disclosure. It is apparent, however, to one skilled in the art, that the present discloser may be practiced without some or all of these specific details. In other instances, well known process steps and/or structures have not been described in detail in order not to unnecessarily obscure the present disclosure. In addition, while the disclosure is described in conjunction with the particular embodiment, it should be understood that this description is not intended to limit the disclosure to the described embodiment. To the contrary, the description is intended to cover alternatives, modifications, and equivalents as may be included within the spirit and scope of the disclosure as defined by the appended claims.

A geo-location based advertisement video is an advertisement video that is shown according to the current geo-location of the viewer. Within the geo-location advertisement video is an advertisement with an “Add to Cart” button or other button of the likes that allows the viewer to click on to add the product or service to a shopping cart. The present invention is a video player that shows online videos (such as movies, episodes, reality TV shows, etc.) and automatically accesses Global Positioning System (GPS) or other geo-location functions supported by the Internet browser, such as Microsoft Internet Explorer, Mozilla Firefox, or Safari and uses the current geo-location of the viewer to show geo-location based advertisement videos. The present invention allows the viewer to add products and services to a shopping cart within advertisement videos with just a click of the “Add to Cart” button or other button of the likes.

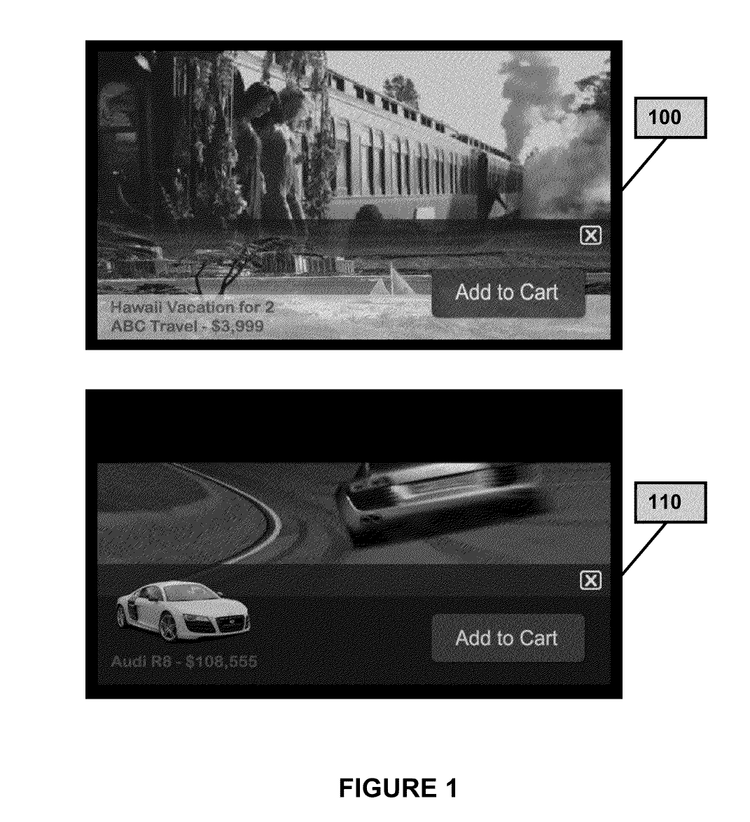

FIG. 1 illustrates examples of two advertisement videos that are shown at different geo-location and viewed by different viewers. For example, while a viewer is watching an online video (such as a movie, episode, reality TV show, etc.) from Washington State, advertisement video 100 appears at various points of the online video. If a viewer from California is watching the same online video, the viewer from California will see advertisement video 110. Advertisement video 100 and 110 are example advertisement videos that may appear. Advertisement videos 100 and 110 can be any advertisement videos. Advertisement video 100 and 110 contains an advertisement with an “Add to Cart” button or other button of the likes that allows the viewer to click on to add the product or service being offered to a shopping cart. Once the online video is done playing or the viewer clicks on the checkout button or other button of the likes, the shopping cart appears for checkout. At checkout, the viewer changes the quantity of the products and/or services, updates the shopping cart, and then pays for the products and services in the shopping cart using his/her credit card or other payment methods.

What is claimed is:

1. A method for displaying geo-location based advertisement videos that contains advertisements with “Add to Cart” button or other button of the likes within an online video, allowing the viewer to add products and/or services to a shopping cart, displaying the shopping cart when the online video is done playing, and allowing the viewer to pay for the products and services using his/her credit card or other payment methods.

2. A method of purchasing products and/or services within an online video, the method comprising the steps of:
watching an online video that shows geo-location based advertisement videos throughout the online video according to the geo-location of the viewer;
viewing geo-location based advertisement video with an “Add to Cart” button or other button of the likes;
clicking the “Add to Cart” button or other button of the likes by said viewer to add product or service to shopping cart;
displaying the shopping cart when the online video is done playing or when the viewer clicks on a checkout button;
paying for the products and services with credit card or other method of payments.

3. The method of claim 2 wherein geo-location based advertisement videos are shown according to the geo-location of the viewer.

4. The method of claim 2 further comprising the step of showing an advertisement with an “Add to Cart” button or other button of the likes.

5. The method of claim 2 further comprising the step of clicking on the “Add to Cart” button or other button of the likes and adding the product or service to a shopping cart.

6. The method of claim 2 further comprising the step of displaying a shopping cart when the online video is done playing or when the viewer clicks on a checkout button.

7. The method of claim 2 further comprising the step of paying for the products and services with credit card or other method of payments.

8. A system of purchasing products and/or services within an online video, the system comprising the steps of:
watching an online video that shows geo-location based advertisement videos throughout the online video according to the geo-location of the viewer;
viewing geo-location based advertisement video with an “Add to Cart” button or other button of the likes;
clicking the “Add to Cart” button or other button of the likes by said viewer to add product or service to shopping cart;
displaying the shopping cart when the online video is done playing or when the viewer clicks on a checkout button;
paying for the products and services with credit card or other method of payments.

9. The system of claim 8 wherein geo-location based advertisement videos are shown according to the geo-location of the viewer.

10. The system of claim 8 further comprising the step of showing an advertisement with an “Add to Cart” button or other button of the likes.

11. The system of claim 8 further comprising the step of clicking on the “Add to Cart” button or other button of the likes and adding the product or service to a shopping cart.

12. The system of claim 8 further comprising the step of displaying a shopping cart when the online video is done playing or when the viewer clicks on a checkout button.

13. The system of claim 8 further comprising the step of paying for the products and services with credit card or other method of payments.
